(19) United States
(12) Patent Application Publication
(10) Pub. No.: US 2003/0007547 A1
(43) Pub. Date: Jan. 9, 2003

(54) Frequency hopping method and system using layered cyclic permutation

(76) Inventor: David Di Huo, Newton, NJ (US)

Correspondence Address: HARNESS, DICKEY & PIERCE, P.L.C., P.O. BOX 8910, RESTON, VA, 20195, US

(21) Appl. No.: 09/862,720

(22) Filed: May 23, 2001

(51) Int. Cl. H04L 27/30

(52) U.S. Cl. 375/132

(57) ABSTRACT

Disclosed is a method for generating frequency sequences in a wireless system. The method for generating frequency sequences creates sequences having a deterministic form. That is, the frequency sequences are created in vector form, where the vector columns represent sequences and the vector rows represent channels.

### BACKGROUND OF THE INVENTION

1. Field of the Invention

The present invention generally relates to mobile radio communications. More specifically, the present invention relates to methods and systems for efficient and flexible use of the frequency spectrum available for communication in a mobile radio communication system.

2. Related Art

Frequency hopping is a technique for ensuring that worst-case interference scenarios do not prevail for longer than one frequency hop interval, as opposed to the duration of an entire communication connection. Frequency hopping also provides frequency diversity, which combats fading experienced by slow moving mobile stations. Moreover, frequency hopping can also be used to eliminate the difficult task of frequency planning, which is of special importance in micro-cells. This can be achieved if all of the cells in a system use the same frequencies but each cell has a different hop sequence. Such systems have been called Frequency Hopping Multiple Access (FHMA).

In a frequency hopping systems each cell can use all of the available frequencies, but at different times, as determined by a pseudo-random frequency hop sequence generator. Such generators can be constructed either to yield a random probability that any two cells may choose the same frequency at the same time (known as non-orthogonal hopping), or to guarantee that specified cells or mobile stations never choose the same frequency at the same time (known as orthogonal hopping), or a mixture of the two techniques (e.g., signals in the same cell hop orthogonally, while being non-orthogonal relative to adjacent cell signals).

A commercial example of a frequency hopping cellular radio system is the Global System for Mobile communications (GSM). The European GSM standard describes this system, which is based on a combination of time division multiple access (TDMA) in which a 4.6 ms time cycle on each frequency channel is divided into eight, 560 μs time slots occupied by different users, and frequency hopping in which the frequencies of each of the eight time slots are independent of one another and change every 4.6 ms.

In a GSM system a channel is described by:

CH=SG(FN, MA, HSN, MAIO, TN),

where SG refers to the hopping sequence generator, FN the frame number, MA the pool of frequencies for mobile allocation, HSN the hopping sequence number, MAIO is the mobile allocation index offset and TN is the time slot index. The pair (HSN, MAIO) defines a sequence assigned to channel CH for each time slot, and each frequency is given a unique number MAI, called a mobile allocation index. The output value of SG is a frequency; therefore, (SG, TN) is a TDMA physical channel. In GSM, MA has N elements, where 1 ≦N≦64. Moreover,

HSN ε{0, 1, . . . , 63}

MAIO ε{0, 1, . . . , N−1}

MAI ε{0, 1, . . . , N−1}.

Each channel on the time axis is identified with a frame number FN. That is, the channel occupies ever eight (8) time slots. As the frequency hopping changes frequency for each user from slot to slot, the time each hop takes is the duration of a frame and is equal to the indicated 4.6 ms.

The hopping sequence of GSM is pseudorandom and therefore its performance is constrained by the pool of available frequencies. In particular, because there are only a finite number of frequencies in the pool, there is repeated usage of the same frequency. The means by which the same frequency is scheduled to repeat within the GSM frequency hopping process is referred to as a sequence generator. Therefore, the sequence generator is not characterized by whether the same frequency repeats, but by how it repeats.

GSM was primarily designed to handle circuit switched voice traffic, and for such use, the pseudorandom hopping sequence used with GSM is sufficient. However, recently the need to support packet switching services has surfaced, which are characterized by bursty traffic. For channel stability, bursty traffic requires high frequency diversity in a short time period.

The current GSM frequency hopping sequence generator is based on randomizing the choice of frequencies from a finite pool of frequencies. Therefore, it is unavoidable to have bursty occurrence of the same frequency for a short period, if the frequency selection is random. Bursty occurrences of the same frequency along the hopping sequence compromises the desired effects of frequency hopping and, as such, compromises the diversity performance and reduces the error correction capability of the system.

### SUMMARY OF THE INVENTION

In order to reduce bursty occurrences of same frequencies during frequency hoping, a short term deterministic approach is used to achieve effective frequency hopping for services using packet switching. In particular, the present invention uses a Layered Cyclic Permutation (LCP) process/algorithm to increase efficiency for frequency hopping systems. The LCP process of the present invention uses vectorized sequences to achieve reduced bursty occurrences of the same frequencies during frequency hopping. The applicability of the LCP process according to the present invention is however not limited to frequency hopping. Instead, the LCP process according to the present invention applies generally to radio systems requiring scheduled resource allocation to achieve maximum usage diversity of the specific resource.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates an exemplary cellular wireless network, such as a Global System for Mobile communication (GSM), using the frequency hopping LCP process according to the present invention; and

FIG. 2 and 3 illustrate, in flowchart form, the LCP frequency sequence process according to the present invention.

### DETAILED DESCRIPTION OF THE PREFERRED EMBODIMENTS

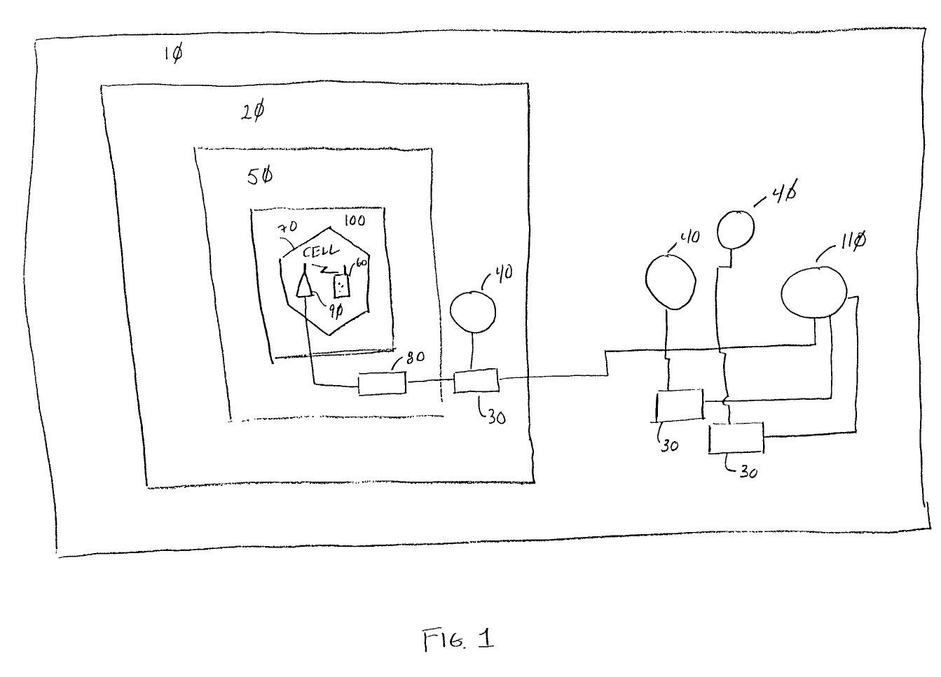

FIG. 1 illustrates an exemplary cellular wireless network, such as a global system for mobile communication (GSM), using the frequency hopping LCP process according to the present invention. The GSM system includes a public land mobile network/area/system (PLMN) 10, which is composed of a plurality of areas 20, each with a mobile switching center (MSC) 30 and an integrated visitor location register (VLR) 40. The areas 20, in turn, include a plurality of location areas (LA) 50, which are defined as part of a given area 20 in which a mobile station (MS) 60 may move freely without having to send update location information to the area 20 that controls the LA 50. Each LA 50 is divided into a number of cells 70. The mobile station (MS) 60 is the physical equipment (e.g., a car phone or other portable phone, used by mobile subscribers to communicate with the cellular network 10, each other, and users outside the subscribed network, both wire-line and wireless).

The MSC 30 is in communication with at least one base station controller (BSC) 80. The BSC 80 is in contact with at least one base transceiver station (BTS) 90. The BTS 90 is the physical equipment, illustrated for simplicity as a radio tower, that provides radio coverage to the geographical part of the cell 70 for which it is responsible. It should be understood that the BTS 90 may be connected to several base transceiver stations 90 and may be implemented as a stand-alone node or integrated with the MSC 30. In either event, the BSC 80 and the BTS 90 components, collectively, are generally referred to as a base station system (BSS) 100.

The area 10 includes a home location register (HLR) 110, which is a database maintaining all the subscriber information, e.g., user profiles, current location information, international mobile subscriber identity (IMSI) numbers, and other administrative information. The HLR 110 may be a co-located with a given MSC 30, integrated with the MSC 30, or alternatively can service multiple MSCs 30, the latter of which is illustrated in FIG. 1.

The VLR 40 is a database containing information about all of the mobile stations 60 currently located within the area 20. If an MS 60 roams into a new area 20, the VLR 40 connected to that MSC 30 will request data about the MS 60 from the HLR database 110 (simultaneously informing the HLR 150 about the current location of the MS 125 ). Accordingly, if the user of the MS 60 then wants to make a call, the local VLR 40 will have the requisite identification information without having to re-interrogate the HLR 110. In the aforedescribed manner, the VLR and HLR databases 40 and 110, respectively, contain various subscriber information associated with a given MS 60.

Each MS 60 is affected by a myriad of signal-degrading phenomena. For instance, small-scale fading (also called multipath, fast or Rayleigh fading) creates peaks and valleys in received signal strength when the transmitted signal propagates through populated areas with signal-reflecting structures. A second-degrading phenomena, large scale fading (also called log-normal fading or shadowing), reduces received signal strength when the transmitted signal is degraded by large objects (e.g., hills, building clusters, force, etc.). A third signal degrading phenomena, co-channel interference, reduces the ability of an MS 60 to correctly receive a desired signal from a first BTS 90 because an undesired signal from a second, more distant, BTS 90 is interfering. Many other signal degrading phenomena (e.g., path loss, time dispersion, and adjacent channel interference) adversely impact wireless communications.

The frequency hopping process and system according to the present invention advantageously combats signal-degrading phenomena. The frequency hopping process according to the present invention is preferably implemented in combination with an MS 60 and a BTS 90, and more generally within a wireless network system such as that shown in FIG. 1. Furthermore, as is well known, the frequency hopping process of the present invention may be implemented in a cell transceiver (TRX) responsible for the Broadcast Control Channel (BCCH). However, it is readily apparent to those skilled in the art that the frequency hopping process and system according the present invention is not limited to the wireless system shown in FIG. 1. Such has been used by way of illustration only.

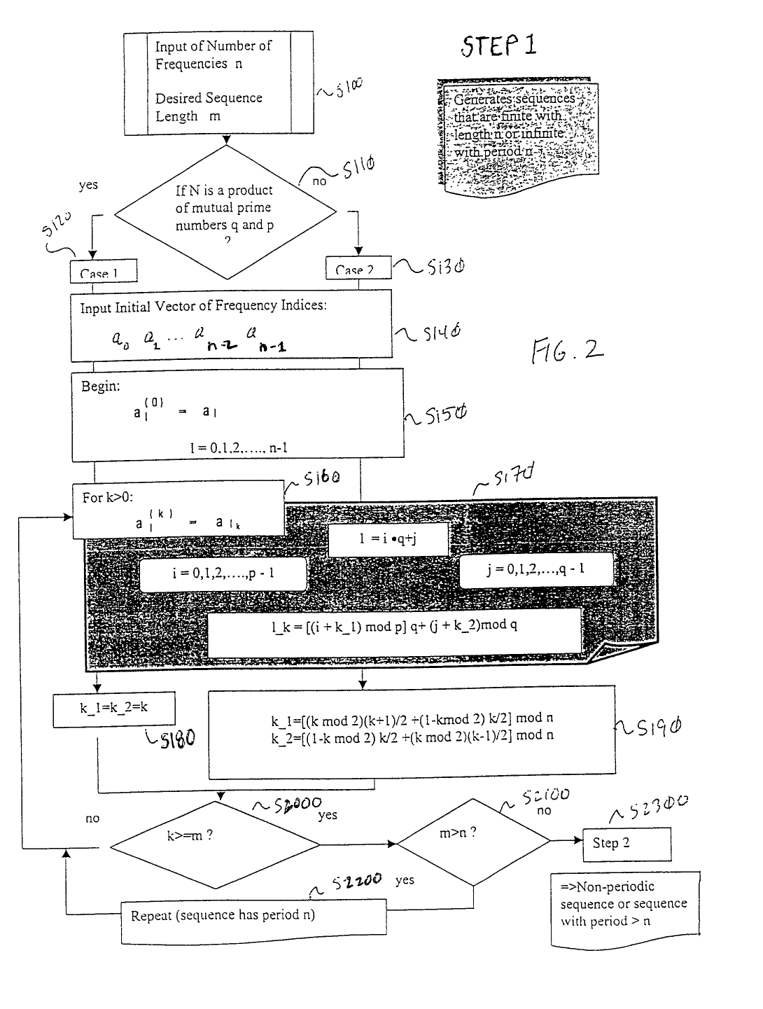

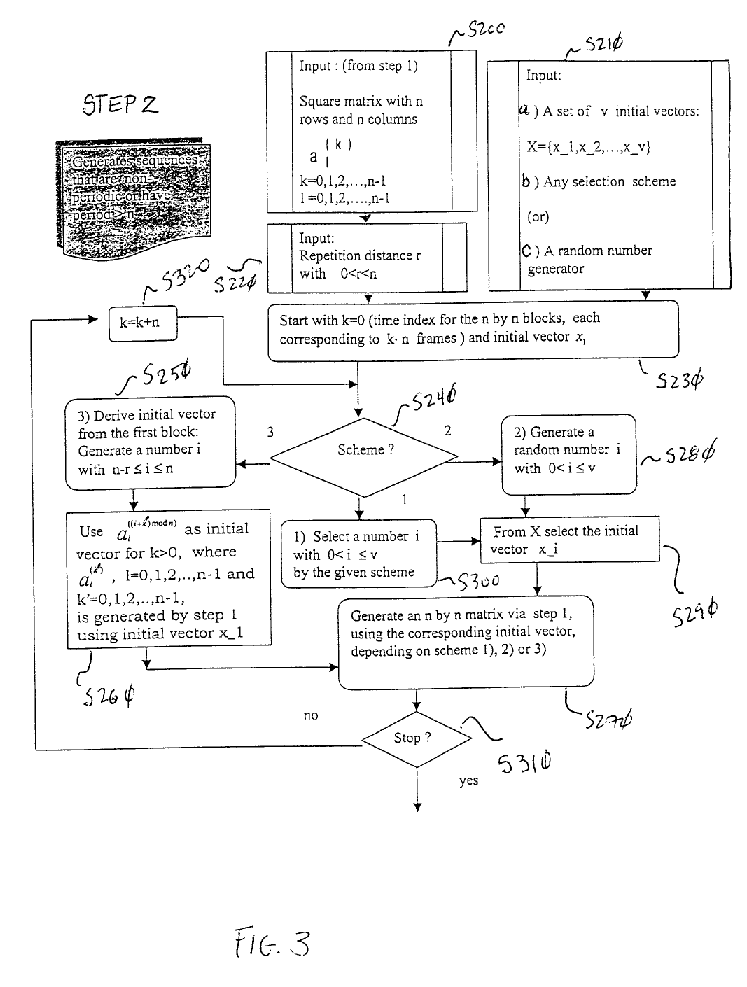

FIG. 2 and 3 illustrate, in flowchart form, the LCP frequency sequencing process according to the present invention. The LCP frequency sequencing process is also discussed hereinafter.

According to the present invention, LCP sequences are generated using two steps:

1. Generate a finite sequence of size n, where n is the number of available frequencies.

2. Generate an infinite sequence using the finite sequence generated in the first step.

As is seen in FIG. 2, the LCP process requires input of a specific number of frequencies n (MA in GSM) along with a desired sequence length m (S100). Once this information is known, the process can be continued in two alternative ways. When n is a product of mutual prime numbers, represented by q and p, case one (1) is followed in the flowchart illustrated in FIG. 2 (S110). Alternatively, when n is not a product of mutual prime numbers, but is even, case two (2) is followed in the flowchart illustrated in FIG. 2. In terms of the sequences generated, both cases (1 and 2) are equivalent.

The LCP process according to the present invention generates an LCP sequence with the frequencies n for two specific cases. In particular, case 1 where n is a product of two mutual prime number q and p (S120), and case 2 where n is even, i.e. q=2 and p=n/2 (S120).

After input of an initial vector of frequency indices and initialization (S140 and S150), a finite sequence is generated based upon the determination in a previous step (S110). In particular, if case 1 (S120), let aₗ ^{(k)} indicate the index of frequencies to hop at a time k for a channel l (S160). For both cases, l can be expressed by (i, j) such that l=i ·q+j, where n=pq. Starting with

$${a}_{l}^{( 0 )} = {a}_{l}$$

for l=0, 1, 2, . . , n−1, the value of aₗ ^{(k)} at the time k is determined by

$${a}_{l}^{( k )} = {a}_{lk}$$

where lₖ is a function of k and l, and is determined through (i, j) by

l ₖ=[(i+k₁)modp]·q+(j+k₂)modq

with i=0, 1, . . . ,p−1 and j=0, 1, . . . ,q−1 (S170).

For case 1:

k₁=k₂=k. (S180)

For case 2:

k₁=[(k mod 2)(k+1)/2+(1−k mod 2)k/2]mod n.

k₂=[(1−k mod 2)k/2+(k mod 2)k−1)/2]mod n (S190).

The additional steps illustrated in the flowchart of FIG. 1 are self-explanatory (S2000-S2300), where S2300 connects the process illustrated in FIG. 2.

Table 1 shows an example for n=6. Since n=2-3 is a decomposition into two mutual prime numbers as well as an even number, both case 1 and case 2 apply.

TABLE 1
Case 1

| 1 = 0, 1, 2,.., 5 | | | | | | | (k) |
|---|---|---|---|---|---|---|---|
| | 3 | 2 | 5 | 4 | 1 | 0 | (1) |
| | 4 | 5 | 0 | 1 | 2 | 3 | (2) |
| | 1 | 0 | 3 | 2 | 5 | 4 | (3) |
| | 2 | 3 | 4 | 5 | 0 | 1 | (4) |
| | 5 | 4 | 1 | 0 | 3 | 2 | (5) |
| | 0 | 1 | 2 | 3 | 4 | 5 | (6) |

Case 2

| l = 0, 1, 2, 3, 5 | | | | | | | (k) |
|---|---|---|---|---|---|---|---|
| | 1 | 0 | 3 | 2 | 5 | 4 | (1) |
| | 2 | 3 | 4 | 5 | 0 | 1 | (2) |
| | 5 | 4 | 1 | 0 | 3 | 2 | (3) |
| | 0 | 1 | 2 | 3 | 4 | 5 | (4) |
| | 3 | 2 | 5 | 4 | 1 | 0 | (5) |
| | 4 | 5 | 0 | 1 | 2 | 3 | (6) |

In Table 1, total blocks for n=6, with an initial value x={0, 1, 2, 3, 4, 5}, and l refers to channels (row) and (k) refers to time (column).

The LCP process for generating an infinite sequence is illustrated in flowchart form in FIG. 3. Input is a square matrix with n rows and n columns, and is obtained from the results of the LCP process shown in FIG. 2 (S200). Alternatively, the input is a set of initial vectors with a specific selection scheme, or a random number generator (S210). If the input is from S200, a repetition distance r is set (S220). The repetition distance r is defined as the minimum number of hops between two occurrences of the same frequency in a sequence. It is readily seen that cyclic hopping in GSM (HSN=0) provides a maximum repetition distance n −1 when there are n frequencies in the pool (MA=n).

Regardless of input, a starting point in the n by n matrix is set. In particular, a time index of k=0 and an initial vector (xₗ for S210) are used (S230). Next, the type of scheme is determined. Specifically, the data input in steps S200 and S210 is considered and a decision as to how to proceed in the process is made (S240). If input from S210 contains neither b) nor c) then the process flow continues to S250. Here, an initial vector from the input matrix is determined, and a number i, where n−r≦i≦n, is generated. The number i is then input into function

a₁^{((i+k)mod n)} (S260).

Next, an n by n matrix is generated (S270).

Based upon the scheme, it is possible to generate a random number i, where 0 <i≦v (S280). Then, using the set X from S210, an initial vector xᵢ is selected (S290). The process then proceeds to S270, discussed hereinabove.

In addition to the above, based upon the scheme, an initial vector from the input matrix may be determined, and a number i, where 0 <i≦v, is generated (S300). Following this step, S290 is processed. Regardless of the step chosen after decision block S240, the steps that occur thereafter ultimately lead to decision block S310. At S310, either the process illustrated in FIG. 3 is stopped, or the time variable k is incremented (S320) and the process of FIG. 3 is repeated.

Given a block (or matrix)

$${\{ {a}_{l}^{( k )} \}}_{l = 0 , k = 0}^{n , n}$$

generated using the process illustrated by the flowchart of FIG. 1, an infinite sequence can be generated block-wise, block-wise with a length n. The blocks can be chosen by random selection of the initial vector

$$x = \{ {a}_{0}^{( 0 )} , {a}_{1}^{( 0 )} , … , {a}_{n - 1}^{( 0 )} \}$$

from n! possible values, or simply by repetition of the same block via

$${s}_{l}^{( t )} = {a}_{l}^{( k )} for k = t mod n$$

which has repetition distance n−1 and period n.

For sequences with longer periods

$${s}_{l}^{( k )} = {a}_{l}^{( k + i ) mod} , i \cdot n \leq k < ( i + 1 ) \cdot n$$

for i=0, 1, 2, . . . ,n−1−r, may be deployed, where r is a given repetition distance, k is the index for n by n blocks, and the symbol “mod” refers to the modulo operation. Using this method of extension of blocks, a time sequence

$${\{ {s}_{l} ( t ) \}}_{t = 0}^{∞}$$

with repetition distance r<n−1 can be generated which has a period (n−r)n².

The mechanism underlying LCP is group operation rather than random selection (GSM FH). The sequences generated by LCP can be better understood if seen in block (matrix) form instead of an independent single sequence. As block, the LCP sequences have the following properties:

A basic block for the LCP sequence is matrix {S_{i,j}} of n by n, where the column index i indicates the time and the row index j indicates different sequences.

A sequence is generated block-wise, and each block is an n by n matrix.

No two columns are equal, i.e. S_{i,j} ≠S_{i,j} for i ≠and no two rows are equal, i.e. S_{i,j} ≠S_{i,j} for j≠j′. Consider the rows as channels, then no channel remains fixed when time advances in column. Consider columns as sequences, then no two sequences contain the same frequency at the same time.

Within the n×n matrix, each frequency occurs only once in a sequence, i.e. the distance of repetition is n−1.

In the case of p=1 or q=1, the sequences generated are mutually offset cyclic sequences (corresponding to HSN=0 in GSM).

Sequences generated using different initial vectors are independent.

By repeating the block consecutively, a periodic sequence with repetition distance 2·1 cm(p, q)−1 is achieved, where 1 cm refers to the least common multiple.

TABLE 2
x = {0, 1, 2, 3, 4, 5}

| l = 0, 1, 2, 3, 4, 5 | | | | | | | (k) |
|---|---|---|---|---|---|---|---|
| | 3 | 2 | 5 | 4 | 1 | 0 | (1) |
| | 4 | 5 | 0 | 1 | 2 | 3 | (2) |
| | 1 | 0 | 3 | 2 | 5 | 4 | (3) |
| | 2 | 3 | 4 | 5 | 0 | 1 | (4) |
| | 5 | 4 | 1 | 0 | 3 | 2 | (5) |
| | 0 | 1 | 2 | 3 | 4 | 5 | (6) |

x = {1, 2, 3, 4, 5, 0}

| l = 0, 1, 2, 3, 4, 5 | | | | | | | (k) |
|---|---|---|---|---|---|---|---|
| | 4 | 3 | 0 | 5 | 2 | 1 | (1) |
| | 5 | 0 | 1 | 2 | 3 | 4 | (2) |
| | 2 | 1 | 4 | 3 | 0 | 5 | (3) |
| | 3 | 4 | 5 | 0 | 1 | 2 | (4) |
| | 0 | 5 | 2 | 1 | 4 | 3 | (5) |
| | 1 | 2 | 3 | 4 | 5 | 0 | (6) |

x = {2, 1, 4, 3, 0, 5}

| l = 0, 1, 2, 3, 4, 5 | | | | | | | (k) |
|---|---|---|---|---|---|---|---|
| | 3 | 4 | 5 | 0 | 1 | 2 | (1) |
| | 0 | 5 | 2 | 1 | 4 | 3 | (2) |
| | 1 | 2 | 3 | 4 | 5 | 0 | (3) |
| | 4 | 3 | 0 | 5 | 2 | 1 | (4) |
| | 5 | 0 | 1 | 2 | 3 | 4 | (5) |
| | 2 | 1 | 4 | 3 | 0 | 5 | (6) |

x = {0, 3, 2, 5, 4, 1}

| l = 0, 1, 2, 3, 4, 5 | | | | | | | (k) |
|---|---|---|---|---|---|---|---|
| | 5 | 2 | 1 | 4 | 3 | 0 | (1) |
| | 4 | 1 | 0 | 3 | 2 | 5 | (2) |
| | 3 | 0 | 5 | 2 | 1 | 4 | (3) |
| | 2 | 5 | 4 | 1 | 0 | 3 | (4) |
| | 1 | 4 | 3 | 0 | 5 | 2 | (5) |
| | 0 | 3 | 2 | 5 | 4 | 1 | (6) |

Table 2 illustrates several frequency sequences where n=6 with (q, p)=(2, 3). The sequences were generated under case 1 of the present invention.

The number of frequencies available for GSM is 64. To determine feasibility of the present invention, it is useful to find out how many n≦64 frequencies exist that allow the process of the present invention to achieve the maximum repetition distance n−1. Here, the trivial case of prime numbers is excluded from discussion, because prime numbers enable cyclic sequences only, albeit with repetition distance n−1 (known). In can be proven using group theory that the maximum repetition distance n−1 can be achieved when n=pq, with p and q being mutual prime, or at least when n is even. Using this result to analyze non-prime numbers n≦64 with respect to the possible decomposition, it turns out there are only two numbers by which the maximum repetition distance cannot be achieved with the LCP process of the present invention, and they are n=9 (LCP yields a sequence with repetition distance 5, while the maximum is 8) and n=25 (LCP yields a sequence with repetition distance 9, while the maximum is 24). Therefore, the conclusion can be drawn that the algorithm would not achieve repetition distance n−1 for n=9 and n=25. Further feasibility and statistical information can be found in the Appendix, document “Frequency Hopping with LCD Sequences” by David D. Huo, the entire contents thereof being incorporated by reference.

The maximum repetition distance is not achieved at the cost of interference diversity. The LCP sequences generated by different initial vectors are independent, meaning their collision probability is no more than two statistically random sequences. In practice, for n frequencies there are n! initial vectors to chose from.

As already mentioned hereinabove, the initial vectors can be chosen deterministically as well as randomly. For a given repetition distance, a random selection of initial vectors from a designated pool of initial vectors can provide a block-wise pseudorandom sequence. Therefore, the sequence is generated in block (matrix) form and the randomization takes place among the different initial vectors.

Referring now to FIG. 3 once again, v initial vectors (out of n!) are determined and put into a pool X (S210). During frequency hopping, a random number i, with 1≦i≦v, is generated each n time units, and an initial vector xₗ out of the set X is selected (S280-S290). The vector is used to generate a basic block, i.e. an n by n matrix (S270). The random number i is generated by a conventional random number generator. The selection of the pool of the initial vectors X is subject to the consideration of repetition distance, or other system/ network requirements.

The deterministic selection of blocks can be done in many different ways. One such selection process is presented herein using the extension of basic blocks in FIG. 3 (scheme 3) according the present invention. However, other possible deterministic (scheduling) approaches, not explicitly discussed herein, are fully embraced by the spirit of the present invention. Therefore, a detailed discussion of such is not required.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1 Introduction

The majority of the new features in GERAN is designed to support efficient packet switched service, which is characterized by bursty traffic. Compared to the circuit switched voice traffic, the requirement for physical channel design is more demanding in terms of stable channel quality. As channel stablity for bursty traffic requires high frequency diversity in short time period. The present paper introduces a deterministic approach to generate frequency hopping sequence. New sequences show statistical property outperforming the GSM FH.

As measure for the frequency diversity we use a metrics called “repetition distance”, which is defined as the minimum number of hops between two occurrences of the same frequency along a sequence. It is readily seen that the cyclic hopping (HSN=0) provides the maximum repetition distance n−1 when there are n frequencies in the pool (MA=n). The repetition distance becomes 0 for non-frequency hopping. However, the cyclic frequency hopping as specified in GSM has adverse impact on the system performance, including on the interference diversity. The goal of this paper is to introduce a sequence generator that can generate non-cyclic sequences with the maximum repetition distance. The algorithm is called “layered cyclic permutation” (LCP).

2 Algorithm

LCP sequences are generated in vector

$${a}_{0}^{( k )} , {a}_{2}^{( k )} , … , {a}_{n - 1}^{( k )} \qquad ( 1 )$$

for discrete time k=1, 2, 3, . . . , in two steps:

1. Generate a finite sequence for k=0, 1, . . . , n−1, where n is the number of available frequencies

2. Generate an infinite sequence using the finite sequence, i.e.

$${\{ {a}_{l}^{( k )} \}}_{l = 0 , k = 0}^{n - 1 , n - 1} ,$$

generated by the first step. * Contact: David D. Huo, dhuo@lucent.com; Document is Lucent Proprietary

TABLE 1
Blocks for n = 6 with initial value x = {0, 1, 2, 3, 4, 5}: l refers to
channels (row) and (k) refers to time (column).
type 1

| l = 0, 1, 2, .., 5 | | | | | | | (k) |
|---|---|---|---|---|---|---|---|
| | 3 | 2 | 5 | 4 | 1 | 0 | (1) |
| | 4 | 5 | 0 | 1 | 2 | 3 | (2) |
| | 1 | 0 | 3 | 2 | 5 | 4 | (3) |
| | 2 | 3 | 4 | 5 | 0 | 1 | (4) |
| | 5 | 4 | 1 | 0 | 3 | 2 | (5) |
| | 0 | 1 | 2 | 3 | 4 | 5 | (6) |

type 2

| l = 0, 1, 2, 3, 5 | | | | | | | (k) |
|---|---|---|---|---|---|---|---|
| | 1 | 0 | 3 | 2 | 5 | 4 | (1) |
| | 2 | 3 | 4 | 5 | 0 | 1 | (2) |
| | 5 | 4 | 1 | 0 | 3 | 2 | (3) |
| | 0 | 1 | 2 | 3 | 4 | 5 | (4) |
| | 3 | 2 | 5 | 4 | 1 | 0 | (5) |
| | 4 | 5 | 0 | 1 | 2 | 3 | (6) |

2.1 Step 1: Basic Sequence

Assume n=pq, say q=2 and p=n/2. Let aₗ(k) indicate the index of frequency to hop at time k for channel l. Furthermore, l can be expressed by (i, j) such that l=i q+j. Starting with aₗ⁽⁰⁾=aₗ for l=0, 1, 2, . . . , n−1, the value of aₗ^{(k)} at time k>0 is determined by

$${a}_{l}^{( k )} = {a}_{{l}_{k}} \qquad ( 2 )$$

where lₖ is a function of k and l, and is determined through (i, j) by

lₖ=[(i+k₁)mod p]·q+(j+k₂)mod q (3)

with i=0, 1, . . . , p−1 and j=0, 1, . . . , q−1, where¹

k₁=[(kmod 2)(k+1)/2+(1−kmod 2)k/2]mod n (4)

k₂=[(1−k mod 2)k/2+(k mod 2)(k−1)/2]mod n. (5)

Table 1 shows an example for n=6. Since n=2·3 is a product of two mutual prime numbers as well as an even number, both type 1 and type 2 apply.

2.2 Step 2: Sequence of Longer Period

Assume {aₗ^{(k)}},l=,0k=0 is generated in the first step. Trivially, an infinite sequence can be generated block-wise, by randomly selecting initial values

x={a₀⁽⁰⁾, a₁⁽⁰⁾, . . . , aₙ−1⁽⁰⁾} (6)

for each block of n by n matrix. Or more simply, by repeating the same block via

$${s}_{l}^{( t )} = {a}_{l}^{( k )} for k = t mod n \qquad ( 7 )$$

a repetition distance n−1 and period n can be obtained. Obviously, there are many ways to extend the period of the sequence. For instance with

$${s}_{l}^{( k )} = {a}_{l}^{( k + i ) mod n} for i \cdot n \leq k < ( i + 1 ) \cdot n , \qquad ( 8 )$$

for i=0, 1, 2, . . . , n−1 −r and k=0, 1, 2, . . . , where r is the given repetition distance, a time sequence {sₗ(t)}ₜ₌ ^{∞}with repetition distance r<n−1 can be generated which has a period ¹ Alternatively, k₁ =k₂ =k, when p and q are mutual prime, which is refered to as type 1. The other case is refered to as type 2.

(n−r)·n². Here we notice a trade-off between the period length and the repetition distance: they are reciprocal. The longest period can be provided by a pseudo random sequence, while the repetition distance approaches zero. Under constraint optimization, one can fix the repetition distance to n−k for a given k>1 and develop schemes to maximize the period, e.g by means of pseudo-random process to select initial value or blocks, or vice versa.

2.3 Property of Basic LCP Sequence

As mechanism underlying the basic LCP sequence is group operation rather than random selection, the LCP sequences can be better understood when viewed in blocks as follows

Each block is a square matrix {s_{i,j}} _{i=0,j=0}^{n-1,n-1} of n×n, where column index i indicates the time and the row index j indicates the vector components, representing e.g. channels

No two columns are equal, i.e. s_{i,j}≠s_{i,′j} for i≠i′ and j=0, 1, . . . , n−1. No two rows are equal, i.e. s_{i,j}≠s_{i,j′}for j≠j′ and i=0,1, . . . , n−1. If the rows represent channels, then no channel remains fixed when time advances in column. If the columns represent the frequency hopping sequences, then no two sequences contain the same frequency at the same time.

Within a block each frequency occurs only once in a row, and each frequency occurs only once in a column.

Each row, as well as column, becomes cyclic, when n=pq with p=1 or q 1.

Sequences generated using different initial vectors are different. 3 Feasibility and Statistics

Not every n allows for LCP sequence with maximum repetition distance. The typical number of frequencies available for frequency hopping in GSM is less than 64. Thus, it is important to find out how many n<64 exist which allow the algorithm to achieve the maximum repetion distance n1. It is proven by means of group theory that the maximum repetition distance can be achieved by LCP, when n is a product of two mutual prime numbers or at least an even number. Here, the case of n being prime is excluded, although it allows for sequence with maximum repetition distance. This is because prime n can only achieve this repetition distance by a cyclic sequence, which is nothing new and not interesting. By analyzing non-prime numbers n<64 with respect to the possible decomposition, it turns out there are only 2 numbers not feasible for the algorithm, they are n=9 and n=25. Therefore, the LCP algorithm with maximum repetition distance is feasible for all non-prime n<64 but n=9 (repetition distance 5) and n=25 (repetition distance 9).

The large repetition distance is not achieved at the cost of the interference diversity. The LCP sequences generated by different initial vectors are independent, meaning their collision probability is no more than two statistically random sequences. The following is an example of deployment scenario:

### EXAMPLE 1

Let n=6 with (q, p)=(2, 3). There are n!=60 possible initial vectors to choose from. Assume the network deployment require a 9 reuse. Then, 9×6=54 different sequences are required, among which 9 are initial vectors. Thus, n=6 is capable of supporting reuse 9 with independent hopping sequences by maximum repetition distance. Table 2 shows 4 block of basic sequences, corresponding to 4 different initial vectors.

TABLE 2
Sequences by n = 6 with (q,p) = (2,3)
x = {0, 1, 2, 3, 4, 5}

| l = 0, 1, 2, 3, 4, 5 | | | | | | | (k) |
|---|---|---|---|---|---|---|---|
| | 3 | 2 | 5 | 4 | 1 | 0 | (1) |
| | 4 | 5 | 0 | 1 | 2 | 3 | (2) |
| | 1 | 0 | 3 | 2 | 5 | 4 | (3) |
| | 2 | 3 | 4 | 5 | 0 | 1 | (4) |
| | 5 | 4 | 1 | 0 | 3 | 2 | (5) |
| | 0 | 1 | 2 | 3 | 4 | 5 | (6) |

x = {1, 2, 3, 4, 5, 0}

| l = 0, 1, 2, 3, 4, 5 | | | | | | | (k) |
|---|---|---|---|---|---|---|---|
| | 4 | 3 | 0 | 5 | 2 | 1 | (1) |
| | 5 | 0 | 1 | 2 | 3 | 4 | (2) |
| | 2 | 1 | 4 | 3 | 0 | 5 | (3) |
| | 3 | 4 | 5 | 0 | 1 | 2 | (4) |
| | 0 | 5 | 2 | 1 | 4 | 3 | (5) |
| | 1 | 2 | 3 | 4 | 5 | 0 | (6) |

x = {2, 1, 4, 3, 0, 5}

| l = 0, 1, 2, 3, 4, 5 | | | | | | | (k) |
|---|---|---|---|---|---|---|---|
| | 3 | 4 | 5 | 0 | 1 | 2 | (1) |
| | 0 | 5 | 2 | 1 | 4 | 3 | (2) |
| | 1 | 2 | 3 | 4 | 5 | 0 | (3) |
| | 4 | 3 | 0 | 5 | 2 | 1 | (4) |
| | 5 | 0 | 1 | 2 | 3 | 4 | (5) |
| | 2 | 1 | 4 | 3 | 0 | 5 | (6) |

x = {0, 3, 2, 5, 4, 1}

| l = 0, 1, 2, 3, 4, 5 | | | | | | | (k) |
|---|---|---|---|---|---|---|---|
| | 5 | 2 | 1 | 4 | 3 | 0 | (1) |
| | 4 | 1 | 0 | 3 | 2 | 5 | (2) |
| | 3 | 0 | 5 | 2 | 1 | 4 | (3) |
| | 2 | 5 | 4 | 1 | 0 | 3 | (4) |
| | 1 | 4 | 3 | 0 | 5 | 2 | (5) |
| | 0 | 3 | 2 | 5 | 4 | 1 | (6) |

To demonstrate the performance of LCP sequences, let

$$r ( k , x , s ) := {min}_{t ∈ {N}_{0}} \{ t \vert {s}_{k + t} ( x ) = {s}_{k} ( x ) \} \qquad ( 9 )$$

measure the repetition distance of sequence {sk}k=O, where k denotes time in frame and x is the initial vector. In practice

$${r}_{mean} = \frac{1}{{n}_{t}} \frac{1}{{n}_{x}} {\sum }_{k = 0}^{{n}_{t}} {\sum }_{i = 1}^{{n}_{x}} r ( k , {x}_{i} , s ) \qquad ( 10 )$$

is adequate to estimate the repetion distance, with

$$E [ r ( k , x ) \vert X ] = {lim}_{{n}_{t} \to ∞} {r}_{mean} , \qquad ( 11 )$$

where E refers expectation and X denotes the set of selected initial vector,i.e. X={X₁, x₂ . . . , xₙ_{_{I}}}; n_{X} number of vectors contained in X. In addition,

$${r}_{dev}^{2} = \frac{1}{{n}_{t}} \frac{1}{{n}_{x}} {\sum }_{k = 0}^{{n}_{t}} {\sum }_{i = 1}^{{n}_{x}} {[ r ( k , {x}_{i} , s ) - {r}_{mean} ]}^{2} \qquad ( 12 )$$

estimates the variance of the repetition distance for sufficiently large nₜ and n_{X}.

To assess the probability of co-frequency collision between sequences generated by different initial values, we use the co-frequency collision ratio for reference sequence k

$${C}_{k} := \frac{1}{{n}_{x} {n}_{t}} {\sum }_{{k}^{′} = 1}^{{n}_{x}} {\sum }_{t = 1}^{{n}_{t}} δ ( {s}_{{k}^{′} , t} , {s}_{k , t} ) \qquad ( 13 )$$

where

$${\{ {s}_{k , t} \}}_{t}^{{n}_{t}} = 0$$

is generated by initial values xₖ, k=1, 2, . . . , n_{X}, respectively, and

$$δ ( u , v ) = \{ \begin{matrix}1 & when u = v \\ 0 & when u \neq v\end{matrix} \qquad ( 14 )$$

The finite number nₜ is the sample size and n_{X}, is the number of initial values used in the evaluation. By nₜ=∞the limit of Cₖ shall be the co-frequency probability, which is independent of k for LCP sequences.

The LCP algorithm of generating frequency hopping sequences is compared with GSM sequence generator via

1. LCP with period n against

2. GSM random sequence generator

Since LCP is deterministic, the repetition distance is known, r_{mean LCP} =n−1. Every GSM sequence (except HSN=0) is generated by pseudo random numbers. Assuming the random number is uniformly distributed, the ideal performance is r_{mean, GSM} =n/2. Thus, for n>2 there is always rₘₑₐₙ,LCP≧r_{mean,GSM} where the equal sign applies when n is prime. In addition, r_{dev,LCP}=0 while r_{dev,GSM>}0.

Again, assume the uniform distribution of the frequencies along the sequence generated by a GSM sequence generator, the ideal co-frequency probability for GSM is C_{GSM}=1/n², given a set of co-frequencies with n elements. As for LCP, which is generated in vector, the collision event should be evaluated between a reference sequence, i.e. a column of a reference t×n matrix, and all n sequences generated simultaneously by another initial vector, i.e. n columns of a t×n matrix generated by a different initial vector. As all n columns of any t×n matrice generated by LCP are orthorgonal, the reference sequence must have collision with exactly one of the other n sequences. That is a probability 1/n. On the other hand, any element of the reference column of the reference t×n matrix moves to the same frequency with a probability 1/n, resulting in a co-frequency collision probability C_{LCP}=1/n2. Since this is independent of the choice of the reference sequence and of the choice of the reference initial vector, conclusion can be drawn that, in terms of co-frequency collision, the LCP has the same performance as an ideal GSM random sequence generator.

4 Conclusion

Aiming at reducing the bursty occurrences of same frequencies during frequency hopping, a new approach (LCP) is developed. The approach allows for frequency hopping sequences being generated vector-wise that demonstrate superior statistic property relevant to frequency hopping. Comparison shows, the LCP algorithm outperforms the current GSM FH sequence generator.

References

[Stage2] 3GPP TSG GERAN Stage 2 Description for GERAN, 3GPP.

[05.02,] GSM 05.02, ETSI

What is claimed is:

1. A wireless system, comprising:
a frequency hopping generator, the frequency hopping generator providing a frequency sequence having a short term deterministic structure, wherein the deterministic structure of the frequency sequence is in matrix form, where each row of the matrix is a vector, and all components of each vector are generated simultaneously.

2. The wireless system according to claim 1, wherein the matrix, having the plurality of vectors, is formed having a greater number of rows than columns.

3. The wireless system according to claim 1, wherein the matrix, having a plurality vectors, is formed having an equal number of rows and columns.

4. The wireless system according to claim 3, wherein the matrix columns and rows are equal to a number of frequencies available within the wireless system.

5. The wireless system according to claim 1, wherein the vectors constitute a square matrix, and each column of the matrix includes unique frequencies.

6. A method of generating a frequency sequence, the method comprising the steps of:
obtaining a number of hop frequencies;
obtaining a specific sequence period;
obtaining a sequence with a given repetition distance;
generating several frequency sequences in vector form; and
generating a matrix including the several frequency sequences in vector form.

7. The method according to claim 6, wherein the generated matrix has an equal number of columns and rows.

8. The method according to claim 6, wherein generating a matrix generates a matrix having a plurality of columns, each column of the columns being unique and orthogonal to all other columns.

9. A method of generating frequency sequences in a wireless system for use in frequency hopping, comprising the steps of:
obtaining a repetition distance value being greater than zero and less than a predetermined number frequencies;
generating infinite mutual orthogonal sequences simultaneously in vector form based upon the repetition distance.

10. The method according to claim 9, further comprising the step of selecting initial vectors used in conjunction with generating the infinite mutual orthogonal sequences.
